(19) United States
(12) Patent Application Publication
(10) Pub. No.: US 2003/0110122 A1
(43) Pub. Date: Jun. 12, 2003

(54) Home equity insurance financial product

(76) Inventors: Barry J. Nalebuff, New Haven, CT (US); Andrew Caplin, New York, NY (US)

Correspondence Address: MORGAN LEWIS & BOCKIUS LLP, 1111 PENNSYLVANIA AVENUE NW, WASHINGTON, DC, 20004, US

(21) Appl. No.: 10/011,829

(22) Filed: Dec. 7, 2001

(51) Int. Cl. G06F 17/60

(52) U.S. Cl. 705/38; 705/37; 705/36

(57) ABSTRACT

A novel financial product and associated data processing system provide risk abatement to purchasers of real estate and/or other assets that are financed and are subject to market valuation changes. The product includes application of a time dependent property index value for adjusting mortgage debt repayment in response to declining property values. The system permits enhanced and expanded lending in targeted neighborhoods on a selected basis.

### FIELD OF THE INVENTION

The present invention, in general terms, is directed to a new form of a financing instrument. More specifically, the present invention is directed to a financial tool and system for enhanced real estate financing with protection against depreciation in housing values.

### BACKGROUND OF THE INVENTION

while the 1990s witnesses an unprecedented increase in the valuations of stocks and other similar securities, the real estate market and holdings in real estate remained a substantial if not dominant asset for individuals. Representing literally trillions of dollars, real estate is a vital reservoir of consumer savings and ultimately, a powerful engine to our economy. Indeed, the importance of home ownership and real estate in general is reflected in tax advantaged treatment of capital gains on housing, interest rate deductions and other governmental subsidies that remain in place as an incentive to home ownership and other real estate investment. It is now generally accepted by economists that real estate investments in general and home ownership is an important factor in the growth and success of the economy, both within specific neighborhoods and nationwide.

In addition to the tax breaks, home ownership is supported by governmental lending organizations such as Freddie Mac and Fannie Mae. These institutions have been incredibly successful in providing an environment that makes lending to purchasers of homes highly efficient and with low risk. Fluid secondary markets permit the free exchange of promissory notes corresponding to mortgages to real estate assets. Together, these vehicles have greatly lowered the effective cost of home ownership, extending the universe of potential purchasers to a broad cross-section of our economy.

While home ownership is part of the American Dream, it can also be a very risky investment. Generally speaking, individuals are not allowed to purchase stock on more than a 50% margin. Yet many people purchase a house on 95%, even 97% margin. As a result, their investment is very highly leveraged. When house prices rise, as they usually do, the person makes a large amount of money and this often helps finance retirement. The problem arises in the cases where the house falls in value. Even a small decline in value can lead to a large financial loss given the large leverage. It is often the case that the people who are most highly leveraged are also the people who are least able to suffer the financial loss.

Although home ownership has helped create wealth and neighborhood growth, there remain neighborhoods that have not shared in the benefits of the system. These are often urban areas and areas of higher unemployment and crime. Houses in these areas have a higher risk of outright depreciation over time. As a result, people who see desirable property and attractive property values are still hesitant to purchase a home in this area due to the legitimate fear that this will not be a good financial investment.

To the extent that people do make a purchase and the home value falls, the results are also problematic. The person can be trapped in that they end up with no equity or even negative equity in their house. Without money for a down payment elsewhere, they have no ability to move in order to take a new job or even refinance their mortgage to take advantage of lower interest rate. The end result is often a high default and foreclosure rate, which leads to further losses. These abandoned properties further reduce the value of the neighborhood. Lenders, recognizing these possible outcomes, often require private mortgage insurance, which can be very costly because of the real risk of default.

The risk of downward movements in house prices interferes with important social objectives in securing enhanced living standards within these areas. There is little debate that increased home ownership often leads to higher employment rates, lower crime, better schools and generally more civic involvement by the residents of the community. The difficulty remains in fostering home ownership in a cost-effective manner. It is with this understanding of the problem that formed the foundation of the present invention.

### OBJECTS AND SUMMARY OF THE PRESENT INVENTION

It is an object of the present invention to provide a financing tool to permit enhanced real estate investment in select areas and regions.

It is another object of the present invention to provide a computerized financial management system.

It is yet another object of the present invention to provide a system for managing and directing the distribution of financing products associated with real estate mortgages.

It is a further object of the present invention to provide a novel financing instrument that reduces the exposure of a mortgage note holder to a real estate asset that declines in value.

It is another object of the present invention to provide a data management system for tracking and controlling financial products that assist in reducing risk exposure in the real estate market.

It is a further object of the present invention to provide event tracking regarding select real estate properties and for maintaining a database regarding these properties in accordance with these events.

Another object of the present invention is to deploy a risk adjustment product that implements a real estate property valuation index that changes over time to reduce equity exposure for homeowners.

The above and other objects of the present invention are realized in a novel data processing system and mortgage related financial product for risk control. The financial product includes implementation of a time-dependent real estate asset valuation index for discerning changes in local, regional, or national real estate values. The index value is periodically assessed and applied to individual mortgage accounts as a form of asset depreciation insurance.

In accordance with the varying aspects of the present invention, the risk management product is implemented on a data processing system so that salient events can be properly tracked, and asset transfer processed in accordance with the governing system logic. A database is linked to the processor, storing core data on each account, supplemented with event data collected periodically and directed to transactions associated with individual accounts and/or properties. System operation is designed for use in a wide spectrum of operative environments. The system is implemented, in a first mode, by the mortgage lending institution, as a form of equity insurance coupled to its loan products. A second mode includes system operation by a dedicated guarantor, contracting with lending institutions for risk insurance products. Other modes, as contemplated herein, will be discussed in detail in conjunction with the various embodiments provided with the detailed specifications.

There is no requirement that operations have regional geographic limitations. As the product is offered on a more national level, the risk is easier to diversify and the expected cost will fall. System operation envisions broad flexibility. For example, the amount of the insurance protection may be equal to the mortgage amount, the house value, amounts in-between, or even more than the home value. This would not be done as a form of gambling. Insurance or risk abatement, in the preferred embodiments, is based on movements in the index value rather than the value of a specific house. As a result, if the predicted movement of the house price is more volatile than the index (in stock market terms, one would say the house has a beta of more than one) then the person might want to purchase protection on more than the value of the home. For example, if a person could predict that a 10% decline in the index would lead to a 20% decline in his or her home value, then the person might want to purchase double protection in order to minimize his or her risk of losing money.

### BRIEF DESCRIPTION OF THE FIGURES

For a more complete understanding of the specific embodiments, FIGS. 1-4 are provided as illustrations relating to the practice of the present invention, wherein:

FIG. 1 is a functional block diagram of the operative entities participating in the present invention;

FIG. 2 is a flow chart depicting the account creation and continuation process; and

FIG. 3 is a flow chart depicting the account management process; and

FIG. 4 is a flow chart depicting the account management process.

### DETAILED DESCRIPTION OF THE INVENTION

First briefly in overview, the present invention, in a first aspect, is directed to a novel financial product used in conjunction with traditional lending vehicles, to modulate the risk otherwise attendant to home financing and ownership. The inventive financial product is linked to the purchase-sale of real estate assets subject to mortgage financing. The financial product is, in part, an insurance vehicle that adjusts the current outstanding balance of the mortgage so that it reflects a decline in the value of the underlying real estate asset. In this way, if the real estate property drops in value at some point in the future, the owner can be partially or fully insulated from this loss.

This insurance/risk modulation is accomplished by establishing a regional index value for the select geographic area where the property is located. This index value is calculated on some periodic basis in an objective manner to ensure accurate reflection of the encompassed property values. There are several commercial enterprises that provide such indices. These include CSW (Case-Shiller-Weiss) and MRAC (Mortgage Risk Assessment Corporation). The government also calculates real estate value indices; OFHEO (Office of Federal Housing Enterprise Oversight) provides a same-sales real estate price index on the web.

It is expected that the index value will be calculated based on market prices of properties in a geographic region. Factors taken into account include historical sale prices, price movements in regions with similar demographics or housing markets, along with many other factors. There is no requirement of any one approach and for purposes of this invention, a myriad of different index valuation techniques may be applicable. For the differing embodiments of the present invention, more than one index value is used in conjunction to effect the risk transfer function. For example, adjustments in loan balance and/or payments may be a function of both regional and national indices. Individual index values, RE(K), are typically time functions of property transfer pricing aggregated across the price spectrum and then normalized for application to the instant property.

A second aspect of the present invention relates to the data processing mechanisms used to implement the commercial application. This data processing system includes hardware distributed on a network, and program controlling software for managing the system. It is expected that in one embodiment, the system will be Web enabled, and in this way, operate on the Internet to permit communication among the various elements of network. Internet operation involves a central server for data retention and security access control. Programming is provided in Web compatible HTML/XML formats to ensure broad compatibility with available Browser technologies.

Entities involved in the creation of risk abatement financing accounts log on remotely for account creation and management functions. Account creation will involve typical data collection processes, per se, well known in the banking community. For example, account data will include select demographic and economic data associated with the borrower(s). Additional select data relating to the real estate property forming the loan collateral is also collected. Recognizing that verified data on the property may be important, system operation includes checks to ensure accuracy. Third party “appraiser” services will link into the process and responsive property value data collected electronically for storage in conjunction with other account data. Confirmation of application fees, etc. is made through banking links.

Risk abatement features will either be set or variable. Variable features stem from targeted financing in select regions and include governmental subsidies, such as neighborhood redevelopment investments, block grants, and the like. Account data, stored in the system database includes details regarding adjustable parameters subject to these forms of subsidies.

Supplementing account creation, system programming further provides assisted approval processing and finally system event management. The approved processing provides screening of account applications to ensure proper implementation of risk abatement financing. The system event management involves the processing of periodic account events (insurance claims, sales transactions, etc.) to update the account data and account participant positions in response to these events.

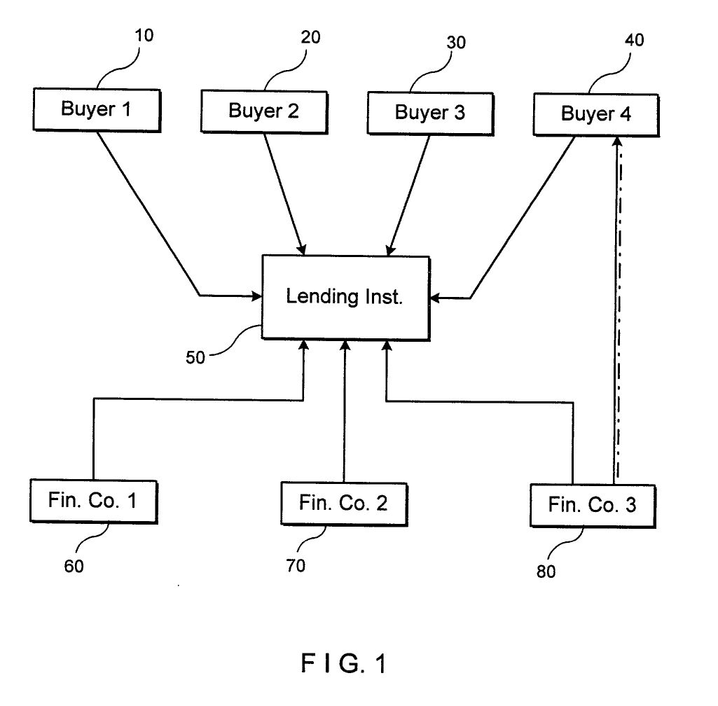

With the foregoing brief background in mind, attention is now directed to FIG. 1. In this figure, the securing of the risk abatement financial product is provided by Lending Institution 50. The Lending Institution can be a bank, money center, or other entity responsible for providing retail mortgage products. Lending Institution 50 has one or more relationships with Secondary Financial Companies 60, 70, and 80. These Secondary Financial Companies specialize in providing the risk abatement product to the Lending Institution, individually or bundled as an aggregate product. Buyers 10-40 interact with the Lending Institution as potential borrowers in financing their acquisition.

The Lending Institution can also provide the risk abatement financial product directly, and, in this arrangement, the Secondary Financial Company's functionality is merged into Lending Institution 50. In addition, the Secondary Financial Companies can offer risk abatement products directly to borrowers as a retail product (e.g., Buyer 40 in FIG. 1). In this arrangement, account data storage and processing occurs at several locations. Funds and commitments to support risk abatement are collected by the Secondary Financial Companies through institutional investors, governmental subsidies, and the like.

### EXAMPLE

A simplified example will illustrate the foregoing operation. For a house purchased at a price of $100,000, the buyer puts down $10,000 and takes out a 30-year $90,000 mortgage at 7.5% interest. A regional index tracks changes in aggregate housing prices. In this example, we have the homeowner taking out protection on the full value of the home, $100,000, and not just the value of the mortgage. If the index falls from 100 to 90, then the homeowner has a $10,000 guarantee that comes in the form of a balloon payment at mortgage termination.

Continuing, this drop in the index occurs after living in the house for five years. At that point, the homeowner has paid off approximately $4,900 in principal. To payoff the rest of the mortgage would thus cost $85,100. Of this amount, $10,000 would be provided by the risk abatement product. Thus, if the homeowner were to sell the house (or more generally prepay the mortgage), the cost of the mortgage payoff would be $75,100.

The net impact on the homeowner is as follows: If real estate prices were to fall by 10% and the house was to be sold for $90,000, the homeowner would payoff $75,100 for mortgage and have $14,900 leftover. However, the homeowner had put down $10,000 with the purchase of the house and paid another $4,900 over the first five years of the mortgage. Thus, the homeowner has paid $14,900 in principal and received all of it back! Although house prices have fallen, the homeowner gets all of his savings and down payment back.

Compare this situation to the status quo. If house prices were to fall by 10%, the entire loss in value would be born by the homeowner. The cost of prepaying the mortgage would be $85,100 and so the homeowner would net only $4,900. This amount reflects his principal payments over the first five years. The entire $10,000 down payment would be lost. In fact, if the homeowner has to pay a 6% commission on the home sale, the homeowner's takeaway amount would be reduced to a negative $500. The person would have lost all of his equity in the home and then some. Even with the risk abatement product, paying the real estate commission would eliminate most of the person's accumulated $4,900 in savings. However, the person would still have $10,000 of his original down payment and thus be able to purchase a house in another location. As such, the risk abatement product has served its essential purpose.

The foregoing example assumes equity protection based on the nominal value of the home. An alternative, albeit more expensive approach provides the protection for the inflation-adjusted or real value of the home or to any other indexed value.

Other adjustments can be made. The payments can be made at the end of the mortgage and thereby leaving the principal and amortization schedule unchanged, or the protection can be provided along the way. For example, consider a case in which $100,000 of protection has been purchased, the mortgage stands at $80,000, and the relevant real estate index has fallen by 10%. One option is to allow the homeowner to payoff the mortgage with $70,000 and have the insurance provided be responsible for the remaining $10,000. Another approach would reduce the mortgage to $70,000 today. In this second scenario, either the term of the mortgage would change and the payments could stay constant or the payments could be reduced and the term could remain constant. Note further that in this approach, if housing prices were to rise, the outstanding principal on the mortgage might rise again. (It is possible to give the mortgage holder the lowest index level or to have the payment in effect be reversed if housing prices return to their original level or higher.)

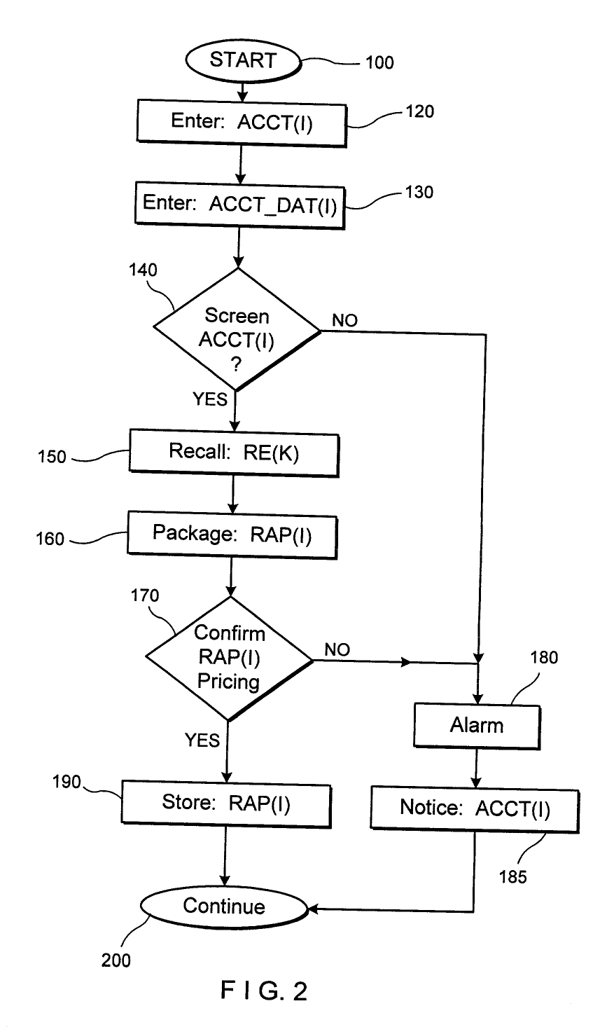

Turning now to FIG. 2, a flow chart depicts the logic structure associated with the account creation process. These are presented in high level generic programming statements for illustration purposes only. Actual system implementation will utilize, per se, well-known software, e.g., Fortran, Cobol, Visual Basic, C++, Pascal, etc., having sufficient ease and flexibility for accomplishing these tasks. Likewise, the system hardware will include network-based CPU's corresponding to the size and complexity required for the specific implementation. Logic conceptually starts at block 100 and account identifier ACCT(1) created at block 120 for future tracking purposes. The system then collects account data, such as buyer/borrower economic data, demographics, and information about the selected property, block 130.

At test 140, the system screens the account data to determine suitability and qualifications of the account applicant for the risk abatement product. Flags at this stage branch logic to Alarm 180.

Continuing with FIG. 2, an applicant that passes screen 140 continues to block 150, where the applicable real estate index is recalled, RE(K) for the specified property/region. The Index is for the current cycle (period) and may be calculated directly, recalled from a separate database and/or adjusted with current data. At block 160, the risk abatement product, RAP(I) is generated for that applicant. This is then tested for suitability with RAP(I) values that fall outside the predefined criteria triggering Alarm 180. If the generated RAP(I) is suitable, logic continues to block 190 to update the database with the approved RAP(I) parameters for that account. Logic continues to the next applicant, block 200.

A further parameter includes a lock-in option, that if selected, allows the user, once a triggering event has reduced the mortgage, to lock in the new lower payment (amount or schedule). In lieu of the lock-in option, the contract may include a “one direction” clause, insuring that only drops in the payment amount or schedule are recognized, and that subsequent rises in value do not affect the payment amount or schedule.

As can be recognized, an important function of the present invention is to provide investment insurance to the borrower. Operation is however, not restricted to conventional mortgages, but compatible to the full spectrum of mortgage financing now on the market or that may develop in the future. This includes all forms of fixed and variable rate products, shared appreciation mortgages, reverse equity mortgages and the like, consistent with the above operating parameters. Expanded use of the system also encompasses pure insurance applications, decoupled from a mortgage product altogether. In this way, property owners, with or without a mortgage, can apply for and receive an account to insure the future value of their property against a slipping real estate market.

Initial pricing of the RAP instrument is system driven and based on stored profiles, user selected parameters, and the pricing matrix available from third party financing suppliers. In the presently preferred embodiment, pricing is coupled to the actual mortgage loan structure, thereby appearing transparent to the borrower. To induce proper third party participation, and to pay for the coverage, pricing is provided to the borrower in the mortgage process as a slightly higher interest rate, additional points towards closing (i.e., prepaid interest) or a combination of rates and points adjustments. Pricing is in conjunction with an existing private mortgage insurance (“PMI”) product or in lieu of such a product, recognizing that the final mortgage rates and points will be influenced by PMI. Reducing the risk of a negative equity position greatly reduces the incentive to default. The expected losses in the event of default are also mitigated because of the insurance payment.

The system further permits instrument structures that extend beyond the value of the underlying real estate asset. For example, the property in question may involve a mortgage of $100,000 and the instrument set to govern a value of $200,000. In this structure, the instrument provides leverage beyond the initial price of the property, permitting a real estate short position by the investor. Alternatively, the amount may remain the same, but a “beta” assigned to the index, multiplying its impact on the principal responsive to a market drop in property value. Of course, the cost of this position is determined in the initial pricing matrix that is subject to the “then” current market conditions.

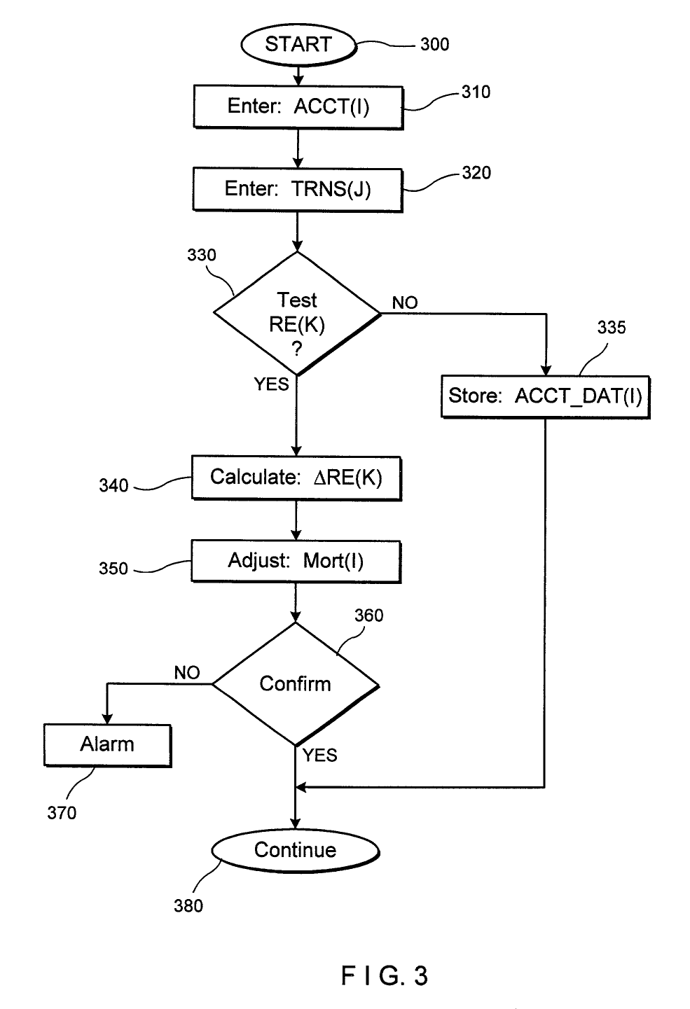

Turning now to FIG. 3, a logic diagram depicts the general processing associated with event management. Recognizing that many events will evoke system processing, any illustrative example directed to a “house sale” event is provided with the understanding that general principles of account processing are applicable to other events (such as refinancing). Logic begins conceptually at Start, block 300, and continues to block 310 for entry of the selected account, ACCT(1). The sales transaction associated with the account is provided at block 320, TRNS(J). Data associated with this transaction includes the index value, RE(K), for that sale period. Test 330 confirms that a drop in the index value has occurred (“Yes”); otherwise, logic branches to block 335, and the storage of final account data, ACCT_DAT(1).

In response to a lower index value, the system quantifies this drop, block 340 and thus calculates the mortgage payoff, MORT(I), with risk abatement adjustment, block 340. This process is checked, test 360, and if confirmed, continues to the next event, block 380.

Implementation of the present invention is provided in several different modes, and is established by the parameters of the risk abatement contract corresponding to the governing instrument. These parameters will have a varying function set, and based thereon, individual users may custom tailor their corresponding policy in accord with their select needs. In one arrangement, the real estate index is tracked and on a periodic (monthly) basis, the system determines whether the property value has dropped by an amount that triggers a mortgage adjustment. If so, the system makes the adjustment which may be expressed in a distinct fashion. For example, if the option is selected, the monthly payment may be reduced by an amount corresponding to the change in the index. Alternatively, the payment schedule may be changed, e.g., requiring 30 payments, down from 36 payments to extinguish the mortgage.

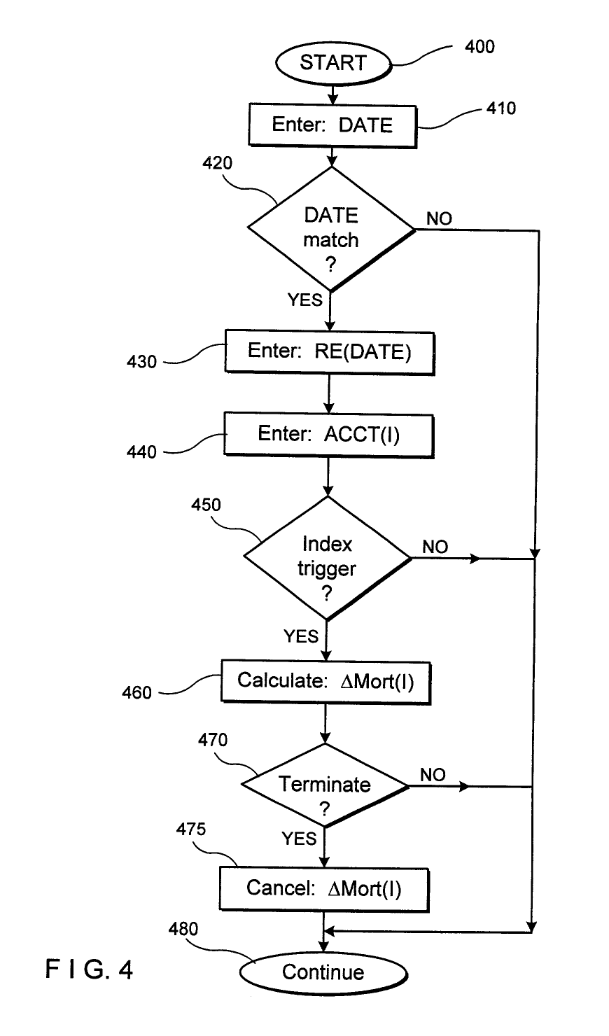

Turning now to FIG. 4, a logic diagram depicts the general processing associated with event management.

In addition to the event driven processing discussed above, system operation may proceed on a time controlled basis, with calculations regarding real estate index changes triggered at select periods during the mortgage term. Processing in this context is presented infra with reference to the logic path depicted in FIG. 4. As presented therein, logic begins conceptually at block 400, and continues to block 410 for entry of the current DATE.

Continuing in FIG. 4, the current DATE value is tested to discern if a adjustment period has occurred, test 420. If the DATE does not match (“No” to test 420), logic branches and processing ends for that cycle. However, a positive match at test 420 continues logic to process the index value and determine whether a mortgage adjustment should be made. This begins at block 430, wherein the current cycle real estate index value in recalled. Again, this value may be recalled from a stored memory location, or calculated in real time from basic data. In either event, at block 440 the system recalls account parameters necessary to determine if a drop in real property value has occurred—and if so, the magnitude of the drop, based on the current index. These are then reviewed at test 450 to discern whether a drop is of sufficient magnitude to trigger a mortgage adjustment during the current cycle. If not, (“no” to test 450) logic branches and processing ends for that account.

A positive response continues logic to block 460, and the system determines the amount of mortgage adjustment triggered by the change in the index. At test 470, the system checks if the drop is of sufficient magnitude to end the mortgage and pay off the loan. If so, logic continues to block 475 and the mortgage is canceled. This is then repeated for the next account, block 480.

Although the invention has been described in detail for the purpose of illustration, it is to be understood that such detail is solely for that purpose and that variations can be made therein by those skilled in the art without departing from the spirit and scope of the invention.

What is claimed is:

1. In combination in a system for managing a plurality of accounts corresponding to loan products wherein said system comprises:
a. data input processor wherein said data includes account data corresponding to borrowers and/or buyers of real estate assets and financing data associated with credit to support asset purchases;
b. market change processor wherein data corresponding to market valuations of asset classes is utilized in an index format to track market value changes of said financed assets; and
c. debt reduction processor that reduces the stored value of an outstanding loan in response to changes in said index.

2. The system of claim 1 wherein said system operates on an event driven basis.

3. The system of claim 2 wherein said events include the sale of the asset and the refinancing of said credit.

4. The system of claim 1 wherein the system operates on a time basis over predefined periods.

5. The system of claim 2 wherein the period is an adjustment cycle wherein an updated index is utilized to discern market value changes in said asset.

6. A novel financial instrument coupled to a lending instrument comprising:
time variant risk abatement by tracking changes in an index associated with aggregate changes—select real estate transactions;
future lending instrument adjustments responsive to a time-based drop in real estate valuation determined by said index; and
final debt reduction commensurate with a measured drop in index value to insure against negative market movements.

7. The financial instrument of claim 6 wherein data associated therewith is processed by one or more computer systems.

8. The financial instrument of claim 6 wherein said lending instrument is a mortgage product distributed by a lending institution.

9. The instrument of claim 7 wherein said lending institution is a bank.

10. The instrument of claim 6 wherein said index is an aggregate value, based on recently consummated real estate transactions within a select region.

11. The instrument of claim 6 wherein said final debt reduction corresponds to a mortgage transaction.

12. The instrument of claim 11 wherein said mortgage transaction is selected from the group consisting of: property sale and note refinance.

13. In combination in a computer processing system for managing a plurality of user accounts, said system comprising:
input subsystem coupled to system memory for receiving and storing information regarding one or more users, wherein said information is stored with an account structured and organized for said user data, said user data further comprising information on the identity of said user and financial information specific to said user; said input/output subsystem further comprising access to memory for storing information regarding one or more real estate properties, said real estate property information including information sufficient to establish a unique identification of said property, said real estate information further comprising data associated with an initial market valuation for said property;
data processing subsystem coupled to system memory for receiving data sufficient to generate a risk abatement instrument corresponding to one or more user accounts, wherein said instrument provides insurance to said user from losses resulting from a drop in market value over a select period of time of said real estate property associated with said instruments; said data processing subsystem further provides an instrument term structure in human readable form for selective output to one or more users; output subsystem coupled to system memory for receiving said instrument term information and providing this information in human readable format.

14. The system of claim 13 wherein said risk abatement instrument is coupled to a time-dependent real estate index value for selectively determining market charges in a predefined real estate marketplace.

15. The system of claim 13 wherein said memory includes plural memory addresses associated with user accounts to support lending institution underwriting protocols.
